(19) United States
(12) Patent Application Publication
(10) Pub. No.: US 2021/0221275 A1
(43) Pub. Date: Jul. 22, 2021

(54) WHEELCHAIR FASTENING DEVICE

(71) Applicant: Chung I Fang, Tainan (TW)

(72) Inventor: Chung I Fang, Tainan (TW)

(21) Appl. No.: 17/151,650

(22) Filed: Jan. 18, 2021

(30) Foreign Application Priority Data
Jan. 20, 2020 (TW) 109102022

(51) Int. Cl. B60P 7/08; A61G 5/10

(52) U.S. Cl. CPC B60P 7/083; B60P 7/0846; A61G 5/10

(57) ABSTRACT

Provided is a wheelchair fastening device, including a housing, a mounting base, a winder and an actuating mechanism. The winder and the actuating mechanism are pivotally mounted on the mounting base. The housing covers the mounting base. The actuating mechanism has a stop piece to limit the rotation of the winder, and has an actuating lever and a gear set. By operating the actuating lever, the stop piece is detached from the winder, and the gear set actuates the winder to perform the action of winding up or pulling out.

### BACKGROUND OF THE INVENTION

### 1. Field of the Invention

The present disclosure relates to a fastening device, and more particularly to a structure suitable for fastening a wheelchair in a vehicle and reducing the displacement of the wheelchair in the vehicle.

### 2. The Prior Arts

The wheel chair fastening device is mainly used to fix the wheelchair to the vehicle. A unidirectional ratchet is used to tightly hook the flexible belt on the wheelchair, so as to prevent the wheelchair from sliding in the traveling vehicle by the tightening force.

For example, the wheelchair fixing device of Taiwan Patent No. M513687 mainly includes a housing and a winder inside the housing. The housing is provided with an outlet. The winder has a reel and a flexible belt. The flexible belt is arranged on the outer periphery of the reel. The flexible belt has a wheelchair hooking end which is pulled out through the outlet to be stretched and shortened. One end of the reel is provided with a knob outside the housing. A unidirectional latch mechanism has a unidirectional ratchet, a blocking piece and a release button. The unidirectional ratchet is connected to the reel. The blocking piece is assembled by a spring such that the abutting edge normally elastically bears against the unidirectional ratchet. The release control part is connected to the blocking piece, and protrudes from the housing so as to control the release control part to disengage the abutting edge from the unidirectional ratchet.

When the user pre-rolls the flexible belt to retract the wheelchair hooking end, it is necessary to control the release control part with one hand, and rotate the knob with the other hand. Two hands must operate two places at the same time to perform the retracting action. Such method is quite inconvenient for the users. Since the knob is coaxial with the unidirectional ratchet, when the wheelchair hooking end is hooked on the wheelchair and the flexible belt needs to be tightened, the knob need to be rotated to force the unidirectional ratchet to rotate in the reverse direction. The unidirectional gear of the unidirectional ratchet against which the abutting edge abuts is displaced, so that the next unidirectional gear abuts against the abutting edge of the blocking piece, thereby causing the flexible belt to be tightened. However, in the state where the knob and the reel are coaxial, the operator is strenuous when turning. As such, how to save effort and facilitate one-handed operation when operating the fastening device is a problem to be improved.

### SUMMARY OF THE INVENTION

In light of the foregoing problems, a main objective of the present disclosure is to solve the problems that the release button and the retractor knob of the fastening device are divided into two components, which must be operated with two hands, thereby causing inconvenience and labor.

A wheelchair fastening device of the present disclosure includes a housing, including a first enclosure and a second enclosure that are opposite to each other, wherein an accommodation space is provided inside the housing, a band outlet is provided on one side of the housing, and a positioning portion is provided on the other side of the housing; a mounting base, fixed in the accommodation space, wherein the mounting base at least includes two side frames opposite to each other; a winder, including at least one unidirectional ratchet, a reel, and a flexible band, wherein two sides of the reel are pivoted at the two side frames, the unidirectional ratchet is connected to the reel, a periphery of the unidirectional ratchet is provided with a plurality unidirectional teeth, the flexible band is rolled around an outer periphery of the reel, the flexible band is provided with a hook, and the hook is operatively pulled out or rolled up by the band outlet of the housing; and an actuating mechanism, including an actuating lever, a pushing piece, an elastic element, a gear set, and a stop piece, wherein the pushing piece and the elastic element are pivoted between the two side frames by the actuating lever, the pushing piece is provided with a tappet, the gear set has a small gear set on the actuating lever, a large gear set on the reel and meshing with the small gear, the stop piece is pivoted on the two side frames and is located between the winder and the pushing piece, the stop piece is provided with an abutment portion, the stop piece is provided with a limit hole surrounding the tappet, a peripheral edge of the limit hole has a guide bevel, a stretching element is arranged between one side of the stop piece and one of the side frames such that a hole wall of the limit hole is operatively separated against the tappet, and the abutment portion abuts on one of the unidirectional teeth in a relaxed state of the elastic element.

As such, the elastic element can be compressed by operating an axial displacement of the actuating lever, the pushing piece moves with the axial displacement of the actuating lever, so that one side of the tappet is pushed against the guide bevel of the limit hole, the change of the guide bevel pushed by the tappet causes the stop piece to be displaced radially with respect to the actuating lever, each abutment portion is disengaged from the unidirectional teeth, and simultaneously rotating the actuating lever cause the gear set to actuate the reel to retract or pull out the hook. Consequently, the purpose of one-handed operation is achieved. Since the present disclosure uses a small gear to drive a large gear, the operator can save effort when operating the actuating lever.

### BRIEF DESCRIPTION OF THE DRAWINGS

FIG. 1 is a three-dimensional schematic diagram of the present disclosure.

FIG. 2 is an exploded three-dimensional schematic diagram of the present disclosure.

FIG. 3 is an exploded three-dimensional schematic diagram showing a winder and an actuating mechanism of the present disclosure.

FIG. 4 is a three-dimensional schematic diagram of assembly of a stop piece and a stretching element of the present disclosure.

FIG. 5 is a partially cross-sectional schematic diagram taken along the line A-A in FIG. 1 according to the embodiment of the present disclosure.

FIG. 6 is a partially three-dimensional cross-sectional schematic diagram taken along the line B-B in FIG. 1 according to the embodiment of the present disclosure.

FIG. 7 shows an operation diagram of the present disclosure.

FIG. 8 is a schematic diagram of the operation of the present disclosure.

FIG. 9 is a schematic diagram of the stop piece according to an embodiment of the present disclosure.

FIG. 10 is a schematic diagram of the operation of the present disclosure.

FIG. 11 is a schematic diagram of the operation of a gear set of the present disclosure.

FIG. 12 is a cross-sectional schematic diagram of the present disclosure.

FIG. 13 is a partially three-dimensional cross-sectional schematic diagram showing a first enclosure and a seat belt buckle seat of the present disclosure.

FIG. 14 is a three-dimensional schematic diagram of the seat belt buckle assembly disposed on the housing according to an embodiment of the present disclosure.

FIG. 15 is a three-dimensional schematic diagram of assembly of the present disclosure with a buckle seat.

FIG. 16 is a schematic diagram of implementation of the present disclosure on a vehicle.

### DETAILED DESCRIPTION OF THE PREFERRED EMBODIMENT

The detailed description of the present invention is provided in combination with the accompanying drawings.

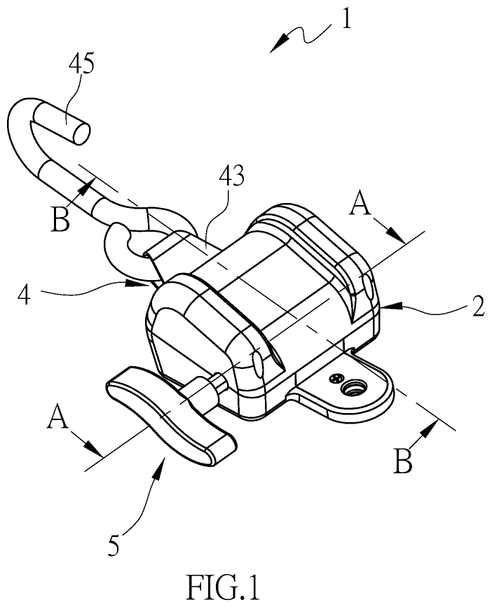

Please refer to FIGS. 1-6. According to a preferred embodiment of the present disclosure, a wheelchair fastening device mainly includes a housing 2, a mounting base 3, a winder 4 and an actuating mechanism 5. The winder 4 and the actuating mechanism 5 are pivotally mounted on the mounting base 3, and the housing 2 covers the mounting base 3.

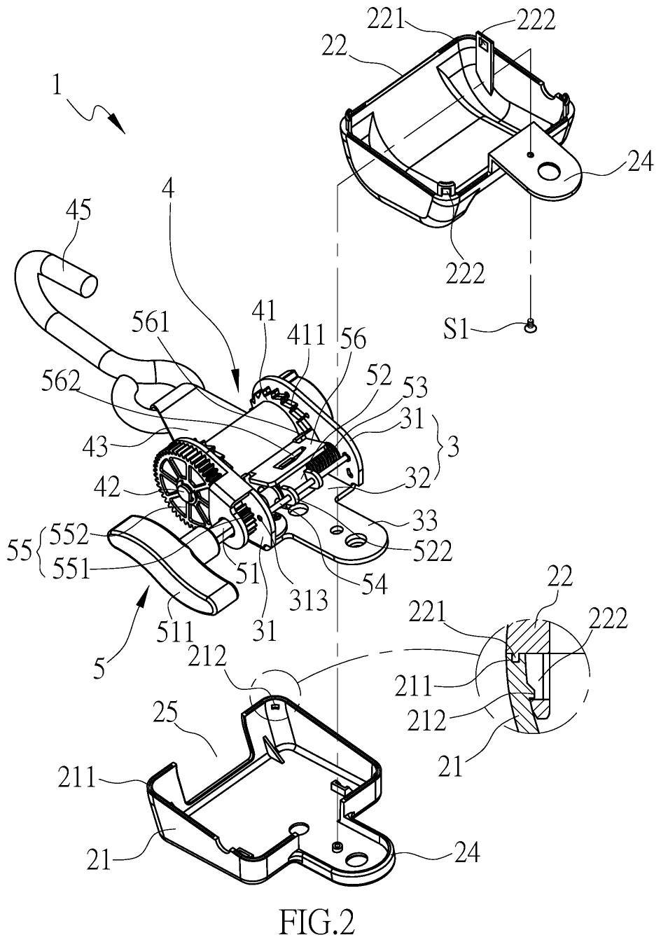

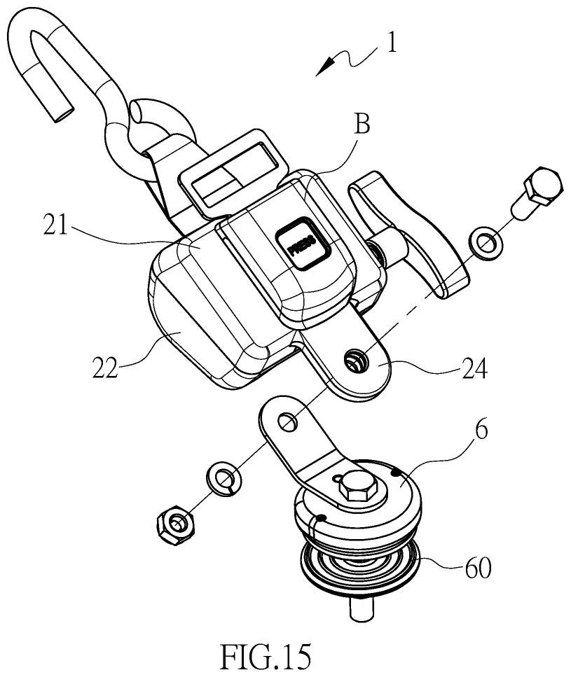

The housing 2 includes a first enclosure 21 and a second enclosure 22 that are opposite to each other. The first enclosure 21 and the second enclosure 22 together define an accommodation space 23. One side of the first enclosure 21 and one side of the second enclosure 22 are respectively provided with a pair of positioning portion 24. The positioning portion 24 can be used for assembling a clip mount 6 (see FIG. 15). A band outlet 25 is provided on the other side of the housing 2. In the embodiment of the present disclosure, the band outlet 25 is provided in the first enclosure 21, but not limited thereto. As shown in FIG. 2, the mating surfaces of the first enclosure 21 and the second enclosure 22 are respectively provided with complementary engagement grooves 211 and convex ribs 221 such that when the first enclosure 21 and the second enclosure 22 are aligned, they have the effect of positioning and alignment. Moreover, the inner wall of the first enclosure 21 is protruded with a plurality of snap portions 212, and the second enclosure 22 is provided with a plurality of snap holes 222. Each of snap holes 222 corresponds to each of snap portions 212. The first enclosure 21 is fixed by inserting the snap portions 212 into the snap holes 222, but not limited thereto. The method of fixing the first enclosure 21 to the second enclosure 22 may also include other fixing methods such as screwing, bonding, welding, etc. It is within the scope of the present disclosure that any method of combining and fixing the first enclosure 21 and the second enclosure 22 is possible.

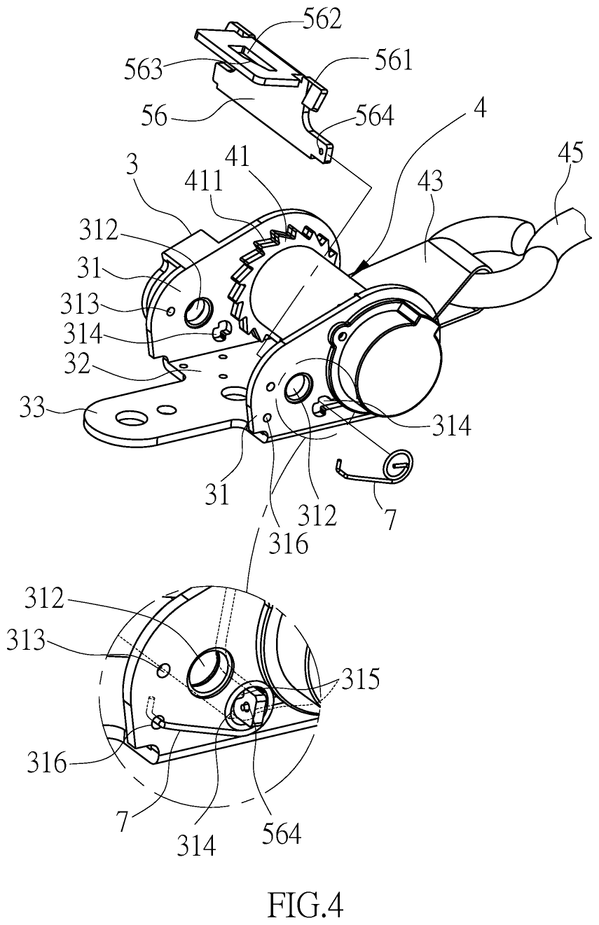

The mounting base 3 is fixed in the accommodation space 23, and at least includes two side frames opposite to each other. The mounting base 3 is further provided with a platform 32 connected to the bottom between the two side frames 31. The mounting base 3 is provided with a positioning ear 33. The positioning ear 33 corresponds to the positioning portions 24 of the first enclosure 21 and the second enclosure 22. A fixing element Si fixes the positioning portions 24 and the positioning ear 33 together. In the embodiment of the present disclosure, the positioning ear 33 extends integrally from one side of the platform 32. Further, each of side frames 31 is provided with a first pivot hole 311, a second pivot hole 312, a third pivot hole 313 and a fourth pivot hole 314. In the embodiment of the present disclosure, the first pivot hole 311 and the third pivot hole 313 are respectively adjacent to the second pivot 312, and the fourth pivot hole 314 is spaced under the second pivot hole 312. As shown in FIG. 4, the fourth pivot hole 314 has projections 315 disposed diagonally.

The winder 4 includes at least one unidirectional ratchet 41, a reel 42, a flexible band 43 and a roll 44. The unidirectional ratchet 41 is provided on one side of the reel 44 in the axial direction. In the embodiment of the present disclosure, two unidirectional ratchets 41 are provided on both sides of the reel 44. A plurality of unidirectional teeth 411 are provided on the peripheral of the unidirectional ratchet 41. The flexible band 43 is wound around the outer periphery of the reel 44, and is also provided with a hook 45. The hook 45 is operably pulled out or retracted from the band outlet 25 of the housing 2. The reel 42 passes through the roll 44, and both ends of the roll 44 are pivotally mounted on the first pivot holes 311 of the two side frames 31 such that the roll 44 can be pivoted with the reel 42. In addition, one end of the reel 42 further passes through one of the side frames 31.

The actuating mechanism 5 includes an actuating lever 51, a pushing piece 52, an elastic element 53, a direction lever 54, a gear set 55 and a stop piece 56. The pushing piece 52 and the elastic element 53 are pivotally mounted on the second pivot holes 312 of the two side frames 31 with the actuating lever 51. The actuating lever 51 penetrates one of the side frames 31, and a handle 511 is provided at the protruding end. The handle 511 is located outside the housing 2. In the embodiment of the present disclosure, two ends of the elastic element 53 are respectively placed between the pushing piece and one of the side frames 31. In the present disclosure, in a normal state, the elastic element 53 is in a relaxed state, and a distance is formed between the handle 511 and the housing 2.

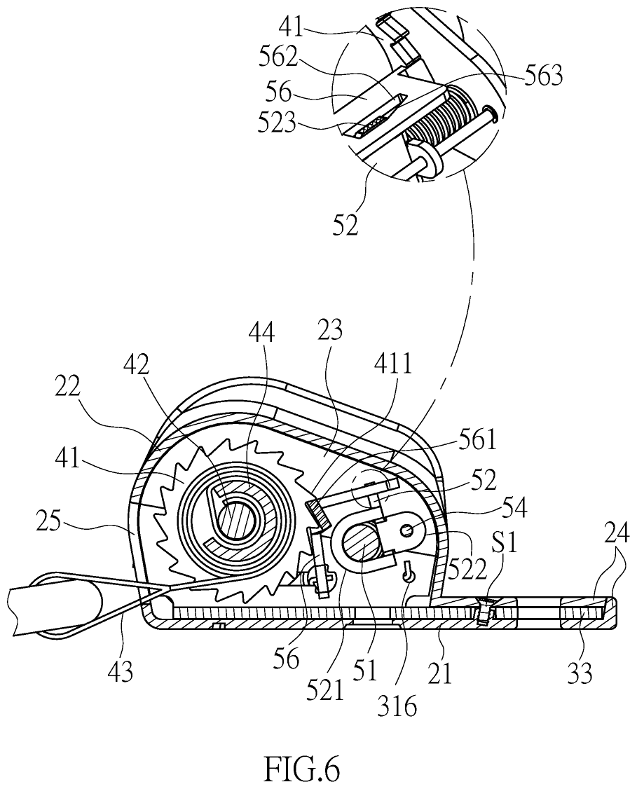

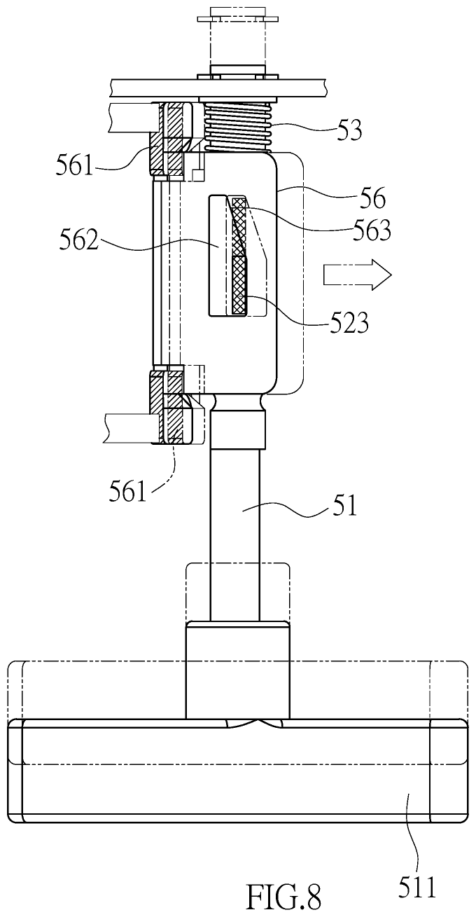

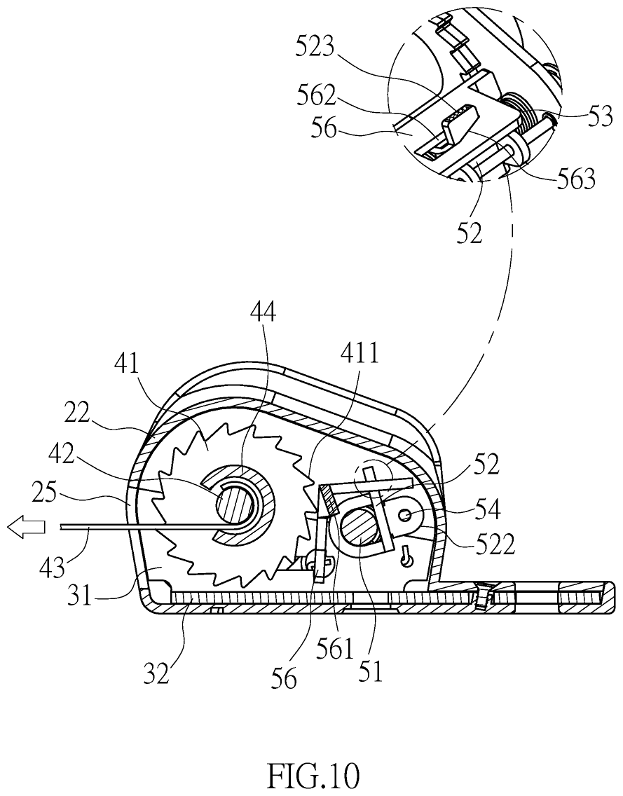

The pushing piece 52 has at least one at least one pivot ear 521 and at least one directional ear 522 opposite to each other. The pushing piece 52 extends upwards to a tappet 523. In FIGS. 6, 8, 9 and 10, the tappet 523 are specifically displayed in a grid to facilitate explanation. The pivot ear 521 is pivotally mounted on the actuating lever 51. The directional ear 522 is pivotally arranged on the third pivot holes 313 of the two side frames 31 with the directional lever 54. In the embodiment of the present disclosure, two pivot ears 521 and two directional ears 522 are taken as examples. The gear set 55 has a small gear 551 and a large gear 552. The small gear is provided at one end of the actuating lever 51 penetrating the side frame 31, and a large gear 552 is provided at one end of the reel 42 penetrating the side frame 31. The large gear 552 meshes with the small gear 551. Moreover, the two ends of the reel 42, the actuating lever 51 and the direction lever 54 are respectively provided with buckles C1 for fixing.

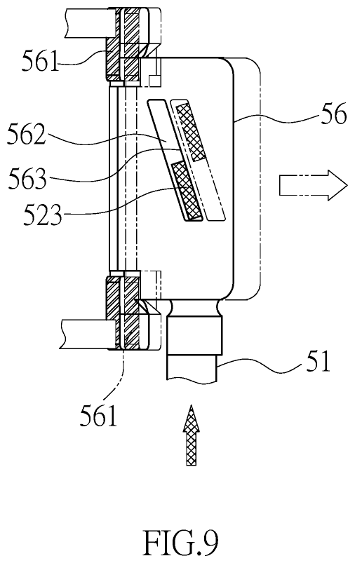

The stop piece 56 is pivotally arranged in the fourth pivot holes 314 of the two side frames 31, and is located between the winder 4 and the pushing piece 52. The stop piece 56 is provided with an abutment portion 561. In FIGS. 6, 8, 9 and 10, the abutment portion 561 is specifically shown with diagonal lines to facilitate explanation. Moreover, a limit hole 562 is provided at the top of the stop piece 561 to surround the tappet 523. The periphery of the limit hole 562 has a guide bevel 563. In the embodiment of the present disclosure, the limit hole 562 is an elongated hole. The arrangement of the guide bevel 563 makes one end of the limit hole 562 form a tapered shape, but not limited thereto. As shown in FIG. 9, the limit hole 562 may also be an elongated oblique hole, and the guide bevel 563 is a part of the elongated oblique hole.

Furthermore, both ends of the bottom side of the stop piece 56 pass through the fourth pivot holes 314. A first perforation 564 is provided at one end of the stop piece 56. The one side frame 31 is correspondingly provided with a second perforation 316, and a stretching element 7 is provided between the first perforation 564 and the second perforation 316. Thus, the bottom side of the stop piece 56 is elastically stretched against the projection 315 provided in the fourth pivot hole 314 such that the hole wall of the limit hole 562 at the top of the stop piece 56 elastically abuts the tappet 523. When the elastic element 53 is in a relaxed state, the abutment portion 561 abuts one of the unidirectional teeth 411 of the unidirectional ratchet 41, thereby restricting the rotation of the reel 42.

As describe above, in order to limit the positions of the actuating lever 51 and the elastic element 53, the actuating lever 51 is provided with a pin hole 512 in the radial direction, and a positioning pin C2 is inserted in the pin hole 512. Two ends of the positioning pin C2 are exposed outside the pin hole 512 such that two sides of the pushing piece 52 are respectively placed between the positioning pin C2 and the elastic element 53.

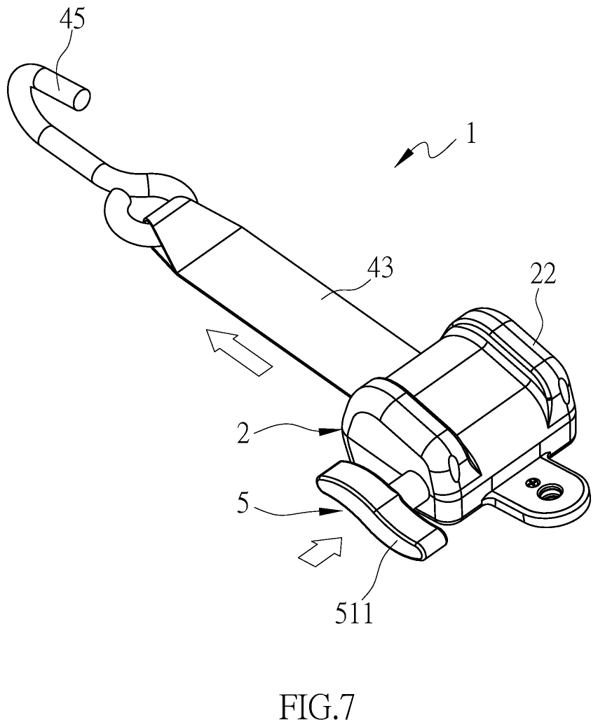

As shown in FIGS. 7-11, the winder 4 and the hook 45 are pulled out. When the user presses the handle 511 to axially displace the actuating lever 51, the elastic element 53 is compressed such that the elastic element is in a compressed state. Thus, the pushing piece 52 is axially displaced along with the actuating lever 51, so that one side of the tappet 523 is pushed against the guide bevel 563 of the limit hole 562. By the change of the guide bevel 563, the stop piece 56 is displaced relative to the radial direction of the actuating level 51, and then each of the abutment portions 561 is enabled to disengage the unidirectional teeth 411 of the unidirectional ratchet 41. The actuating level 51 is simultaneously rotated to make the small gear 551 drive the large gear 552 to rotate, thereby pulling the reel 42 to pull out the hook 45. After that, the handle 511 is released to restore the elastic element 53 to a relaxed state, and the abutment portion 561 of the stop piece 56 abuts the unidirectional teeth 411, thereby restricting the rotation of the reel 42. When the hook 45 is to be retracted, the same operation can be performed by pressing the handle 511 and rotating in the reverse direction.

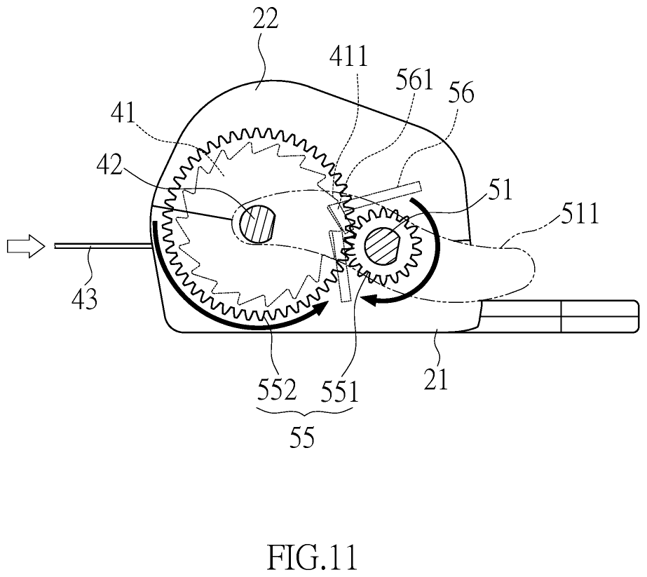

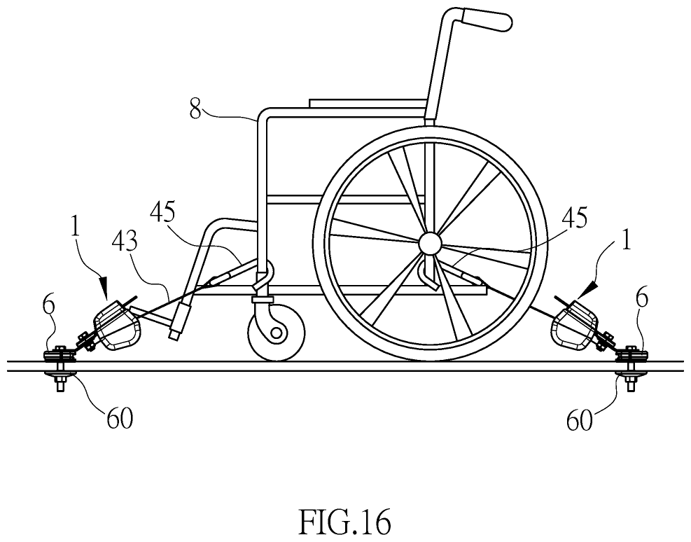

As shown in FIGS. 11 and 16, when the hook 45 is hooked on the wheelchair 8, the flexible band 43 is pre-tightened. By rotating the actuating level 51 with the handle 511, the abutment portion 561 is limited by the stretching element 7 at the bottom, and the top is limited by the limit hole 562 such that the unidirectional teeth 411 reversely rotate and push against the abutment portion 561 to elastically disengage from the unidirectional teeth 411. The next unidirectional teeth 411 is abutted against the abutment portion 561 to complete the action of adjusting the tightening of the flexible band 43.

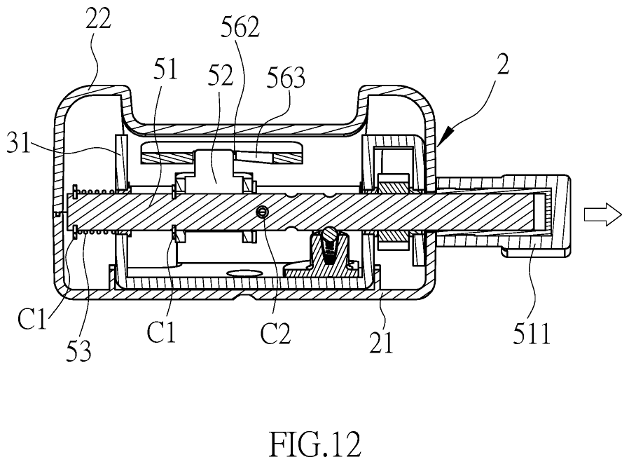

Please refer to FIG. 12, which shows another embodiment of the present disclosure. The difference between this embodiment and the previous embodiment is that the user compresses the elastic element 53 by pulling the handle 511. The configuration of the structural elements is the same as that of the previous embodiment, and will not be described again. Only the structural differences will be described below. In another embodiment of the present disclosure, two sides of the pushing piece 52 are respectively limited by the positioning pin C2 and the buckle C1. The guide bevel 563 of the limit hole 562 is arranged opposite to the previous embodiment. The elastic element 53 is disposed outside one of side frames 31 to form an interval with the handle 511. The actuating level 51 extends through the side frame 51, and a buckle C1 is arranged at the end thereof. The elastic element 53 is disposed between the side frame 51 and the buckle C1. When the elastic element 53 is in a relaxed state, the handle 511 is attached to the housing 2. Therefore, the handle 511 is pulled out during operation.

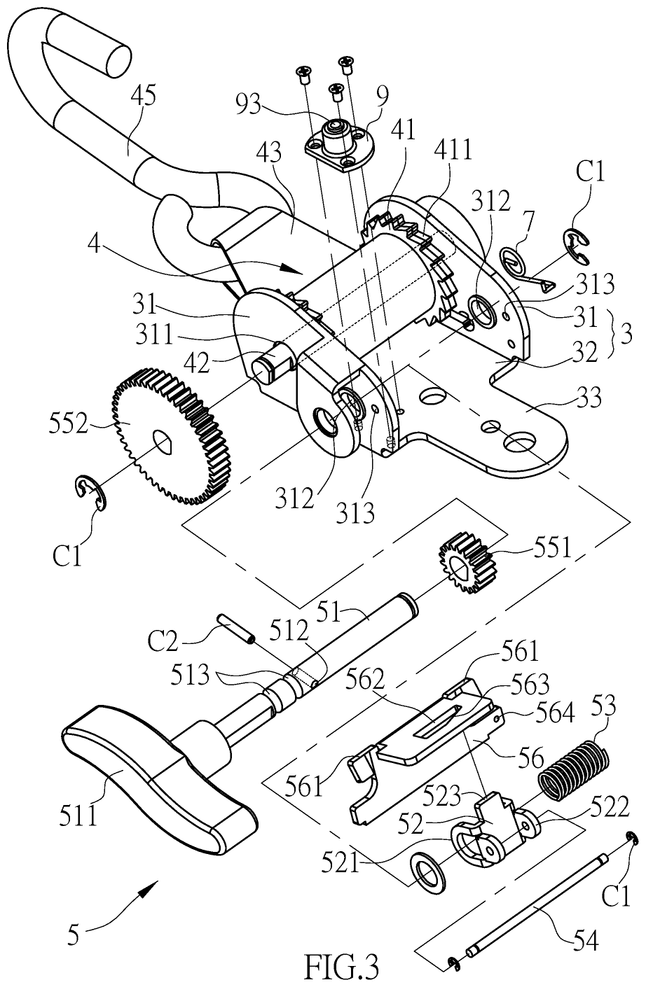

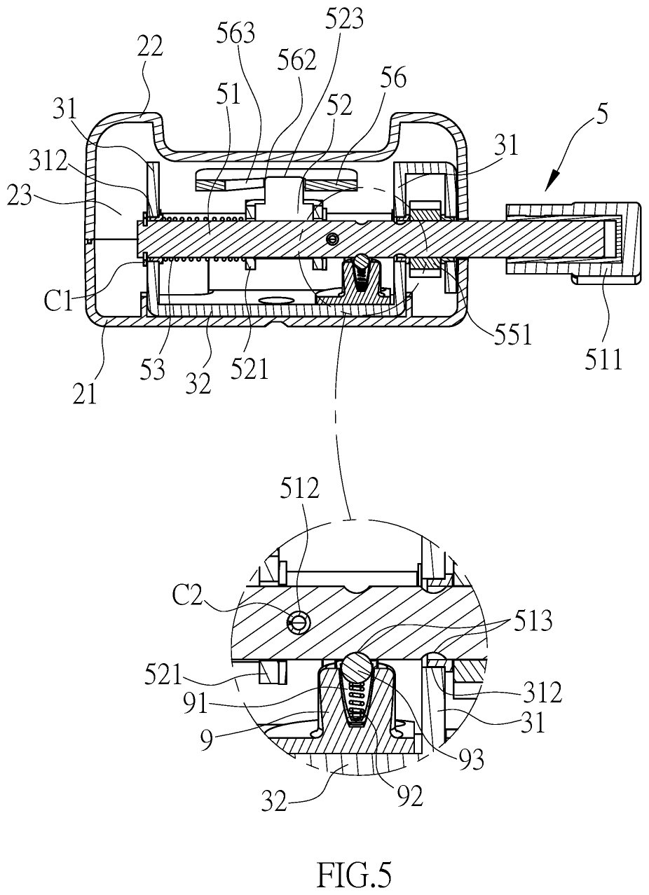

As shown in FIGS. 3 and 5, in order to prevent the operator's operating force from being too large when pressing or pulling out, the actuating lever 51 is surrounded by two spaced grooves. A support base 9 is fixed on the platform 32 of the mounting base 3, and the support base 9 is provided with a notch 91 facing the actuating lever 51. The notch 91 provided with a spring 92 and a positioning steel ball 93 in sequence from the bottom of the notch 91 to the top of the notch 91. One side of the positioning steel ball 93 abuts in one of the grooves 513 to operate the compression of the elastic element 53. The positioning steel ball 93 is pressed against the outer edge of the actuating lever 51, and the positioning steel ball 93 is pushed and dropped into another groove 513 for positioning by the elastic force of the spring 92. This operation feel is used to remind the operator to apply proper force.

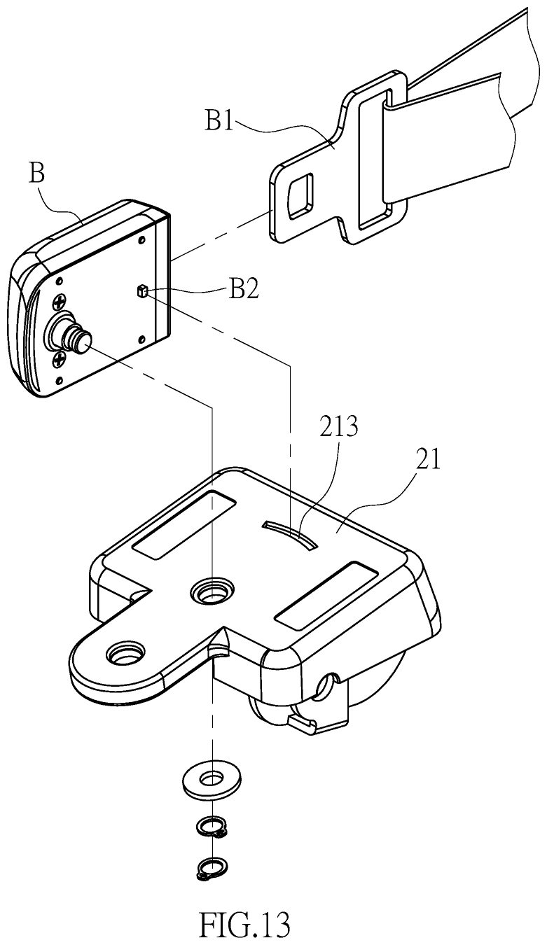

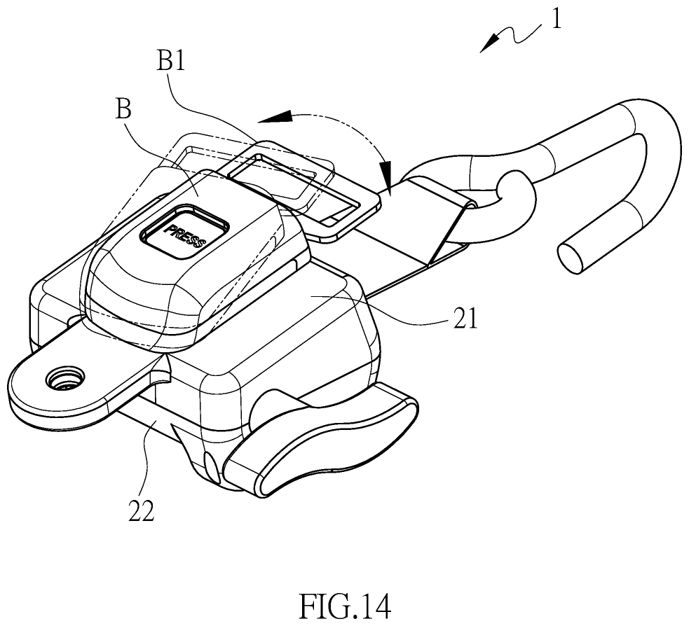

Continuing to refer to FIGS. 13-15, the present disclosure further includes a seat belt buckle seat B pivotally disposed on the outside of the first enclosure 21. The seat belt buckle seat B may be used for the seat belt buckle B1 of the vehicle to be buckled into and fixed. The wall surface of the seat belt buckle seat B facing the first enclosure 21 is provided with a bump B2. The first enclosure 21 is correspondingly provided with a chute 213. When the seat belt buckle B1 is buckled into the seat belt buckle seat B, the position of the seat belt can be adjusted relative to the human body or the wheel chair 8 by sliding the bump B2 within the range of the chute 213. In addition, the positioning portion 24 of the housing 2 is combined with a clip mount 6, and the clip mount 6 is combined with the fixing base 60 of the vehicle floor to achieve the effect of the fixing and tightening of the wheelchair 8.

In summary, the present disclosure allows the stop piece 56 to be separated from the unidirectional ratchet 41 by one-handed operation, and at the same time, the hook 45 can be retracted or pulled out to achieve convenient operation. Moreover, since the winder 4 and the actuating mechanism 5 are respectively pivotally connected to the mounting base 3, the detent operation of the gear set 55 can be sued to achieve the purpose of labor-saving operation.

Although the present disclosure has been described with reference to the preferred exemplary embodiments thereof, it is apparent to those skilled in the art that a variety of modifications and changes may be made without departing from the scope of the present disclosure which is intended to be defined by the appended claims.

What is claimed is:

1. A wheelchair fastening device, comprising:
a housing, including a first enclosure and a second enclosure that are opposite to each other, wherein an accommodation space is provided inside the housing, a band outlet is provided on one side of the housing, and a positioning portion is provided on the other side of the housing;
a mounting base, fixed in the accommodation space, wherein the mounting base at least includes two side frames opposite to each other;
a winder, including at least one unidirectional ratchet, a reel, and a flexible band, wherein two sides of the reel are pivoted at the two side frames, the unidirectional ratchet is connected to the reel, a periphery of the unidirectional ratchet is provided with a plurality unidirectional teeth, the flexible band is rolled around an outer periphery of the reel, the flexible band is provided with a hook, and the hook is operatively pulled out or rolled up by the band outlet of the housing; and
an actuating mechanism, including an actuating lever, a pushing piece, an elastic element, a gear set, and a stop piece, wherein the pushing piece and the elastic element are pivoted between the two side frames by the actuating lever, the pushing piece is provided with a tappet, the gear set has a small gear set on the actuating lever, a large gear set on the reel and meshing with the small gear, the stop piece is pivoted on the two side frames and is located between the winder and the pushing piece, the stop piece is provided with an abutment portion, the stop piece is provided with a limit hole surrounding the tappet, a peripheral edge of the limit hole has a guide bevel, a stretching element is arranged between one side of the stop piece and one of the side frames such that a hole wall of the limit hole is operatively separated against the tappet, and the abutment portion abuts on one of the unidirectional teeth in a relaxed state of the elastic element,
wherein the elastic element is compressed by operating an axial displacement of the actuating lever, the pushing piece moves with the axial displacement of the actuating lever, so that one side of the tappet is pushed against the guide bevel of the limit hole, the change of the guide bevel pushed by the tappet causes the stop piece to be displaced radially with respect to the actuating lever, each abutment portion is disengaged from the unidirectional teeth, and simultaneously rotating the actuating lever cause the gear set to actuate the reel to retract or pull out the hook.

2. The wheelchair fastening device of claim 1, wherein the mounting base is provided with a positioning ear corresponding to the positioning portion of the housing, and the positioning ear is fixed to the positioning portion with a fixing element

3. The wheelchair fastening device of claim 1, wherein a handle is provided at one end of the actuating lever, and the handle is located outside the housing.

4. The wheelchair fastening device of claim 1, wherein the actuating mechanism further includes a direction lever, the pushing piece is provided with a directional ear, and the directional ear is pivoted between the two side frames by the direction lever.

5. The wheelchair fastening device of claim 1, wherein the actuating lever is provided with two grooves which are spaced apart, a platform is provided between the two side frames of the mounting base, a support base is fixed on the platform, the support base is provided with a notch facing the actuating lever, the notch is provided with a spring and a positioning steel ball in order from the bottom of the notch to the slot of the notch, one side of the positioning steel ball abuts in one of the grooves such that the elastic element is compressed, the positioning steel ball is pressed against an outer edge of the actuating lever, and the positioning steel ball is positioned in another groove by a spring force.

6. The wheelchair fastening device of claim 1, wherein an inner wall of the first enclosure is provided with a plurality of snap portions spaced apart from each other, the second enclosure is provided with a plurality of snap holes, each of the snap holes corresponds to each of the snap portions, and each of the snap portions of the first enclosure is embedded and fixed in each of the snap holes of the second enclosure.

7. The wheelchair fastening device of claim 1, wherein the actuating lever compresses the elastic element in an axial compression or pull out manner.

8. The wheelchair fastening device of claim 1, wherein the actuating lever is provided with a pin hole in a radial direction, a positioning pin is penetrated in the pin hole, two ends of the positioning pin are exposed from the pin hole, two sides of the pushing piece are abutted between the positioning pin and the elastic member, and another end of the elastic member is abutted against one of the side frames.

9. The wheelchair fastening device of claim 1, wherein the stop piece is provided with a first perforation, one of the side frame is provided with a second perforation, and two ends of the stretching element are respectively arranged in the first perforation and the second perforation.

10. The wheelchair fastening device of claim 1, wherein the winder further includes a roll disposed on the outer periphery of the reel for winding the flexible band.

11. The wheelchair fastening device of claim 1, further comprising: a seat belt buckle seat, pivotally arranged outside the first enclosure, wherein the seat belt buckle seat is provided with a bump facing the first enclosure, the first enclosure is provided with a chute correspondingly, and the bump slides in the range of the chute.
